(19) United States
(12) Patent Application Publication
(10) Pub. No.: US 2014/0244393 A1
(43) Pub. Date: Aug. 28, 2014

(54) FALL-BACK TO SAVED LOCATION WHERE USER LOCATION IS UNKNOWN

(71) Applicant: GOOGLE INC., Mountain View, CA (US)

(72) Inventors: Graeme Rimmer, Twickenham (GB); Jonathan Leslie Skeet, Reading (GB)

(73) Assignee: GOOGLE INC., Mountain View, CA (US)

(21) Appl. No.: 13/781,711

(22) Filed: Feb. 28, 2013

(51) Int. Cl. G06Q 30/02

(52) U.S. Cl. CPC G06Q 30/0261
USPC 705/14.58

(57) ABSTRACT

Presentation of a saved offer with a redemption location closest to a user's location. The user reviews and selects an offer, creating an offer instance. The user's current location at the time the offer instance is created is identified. The user's current location and the offer instance are saved by a user device. The user accesses the offer instance using an application resident on the user device. If the device cannot identify the user's current location or the application is not integrated with the device's location system, the user's last known location is identified by retrieving the location saved with the offer instance. Alternatively, the user device will determine the most recent saved location, or most relevant last known location. The user's last known location is retrieved and the nearest redemption locations are displayed with the offer.

### TECHNICAL FIELD

The present disclosure relates generally to an offer presentation system, and more particularly to methods and systems that allow the offer presentation system to present a saved offer with a redemption location closest to a user.

### BACKGROUND

Merchants offer coupons or rebates as incentives for purchasing particular products. Traditionally, coupons are distributed in a paper format. A user redeems the coupon by taking the physical coupon to a merchant and purchasing a product that satisfies the terms of the coupon. Other forms of traditional coupons include rebates for purchasing particular products, wherein after purchasing a product that satisfies the terms of the rebate offer, the user fills out and returns required forms to request the rebate.

More recently, merchants have offered electronic offers. Such offers may be linked to merchant loyalty cards, wherein a user enrolls in a merchant's loyalty program and receives a loyalty card. A user then associates certain discounts to the loyalty card and redeems these discounts by presenting the loyalty card (or some form of identifying information, such as a telephone number) and the method of payment to the merchant when purchasing the discounted products. In other circumstances, discounts are automatically associated with the loyalty card and are redeemed by presenting the loyalty card (or some form of identifying information, such as a telephone number) and the method of payment to the merchant when purchasing the discounted products.

With the advent of smart phone technology, merchants are now able to present users with electronic offers that are accessed and saved using an offer application resident on a wireless communication device. Users can search for offers using various offer applications and present a selected offer to a merchant for redemption without requiring paper coupons, loyalty cards, or rebate forms.

### SUMMARY

In certain example aspects described herein, a method for presenting a saved offer with the closest redemption location comprises a user device that saves a user's current location when the offer is selected by the user. The user reviews and selects an offer, creating an offer instance. The user's current location at the time the offer instance is created is identified using a global positioning system (“GPS”), maps application, or cellular tower triangulation. The user's current location and the offer instance are saved in a central management system user account and replicated on the user's devices.

The user accesses the offer instance using an application resident on the user device. If the device cannot identify the user's current location or the application is not integrated with the device's location system, the user's last known location is retrieved. In an example embodiment, the user's last known location is the location saved with the offer instance. In an alternative example embodiment, the user's last known location is a location last identified by the location system or a maps application. In another alternative example embodiment, the application determines the most recent and/or most relevant last known location by accessing one or more saved offer instances. The user's last known location is retrieved and the nearest redemption locations are displayed with the offer.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an operating environment for an offer presentation system, in accordance with certain example embodiments.

FIG. 2 is a block flow diagram depicting a method for presenting a saved offer with the closest redemption location, in accordance with certain example embodiments.

FIG. 3 is a block flow diagram depicting a method for creating an offer instance, in accordance with certain example embodiments.

FIG. 4 is a block flow diagram depicting a method for identifying a user location, in accordance with certain example embodiments.

FIG. 5 is a block diagram depicting a computer machine and module, in accordance with certain example embodiments.

### DETAILED DESCRIPTION OF EXAMPLE EMBODIMENTS

### Overview

The example embodiments described herein provide computer-implemented techniques for enabling presentation of a saved offer with the closest redemption location. A user computing device saves the user's current location when the offer is first selected or saved. An offer is created by a merchant, manufacturer, and/or alternative offer provider and distributed to potential users. In an example embodiment, the offer is a non-prepaid offer for which the user does not pay a fee to obtain (for example, a loyalty reward, a coupon, discounts, or other offer redeemable with a merchant, manufacturer, service provider, and/or provider of goods). In an alternative example embodiment, the offer is a prepaid offer, and the user pays a predetermined price for the goods and/or services that comprise the offer.

The user operates the user computing device to select one or more offers distributed by the offer system or by others through various distribution channels. In an example embodiment, the user selects the offer by clicking on it, pressing a button to “save” the offer, or by other suitable operation to indicate a desire to select and/or save the offer. In an alternative example embodiment, the offer is a prepaid offer, and the user selects the offer by purchasing the offer. The user can download, select, scan, or otherwise capture the offer via the user computing device and import the offer specifics (such as merchant, product, value, redemption rules, and other specifics) to the user computing device.

When the user operates the user computing device to select and save a non-prepaid offer and/or to select and purchase a pre-paid offer, an electronic offer instance is created in the user computing device. The user's current location at the time the offer instance is created is identified. In an example embodiment, a location system operating on the user computing device attempts to identify the user's location based on a location of the user computing device at the time the offer was selected. In an example embodiment, the location system determines whether GPS is available on the user device. In an alternative example embodiment, the location system determines whether a map location is known. In this example embodiment, the user may browse offers available near the user's location and/or the offers may be presented using a map application on the user device. In an alternative example embodiment, the user computing device may access a map application to determine the user's location or last known location. In an alternative example embodiment, the offer system or central management system determine whether a map location is known. In an alternative example embodiment, the location system determines whether a cellular tower triangulation is available for the user computing device. In an alternative example embodiment, the offer system or central management system determines the location of the user device using cellular tower triangulation. In an alternative example embodiment, the user's location may be determined by any suitable means. For example, the user may be prompted to enter a current location when the offer is selected or the user, the user computing device, and/or an offer or map application may set a default location to be saved with selected offers.

The user's current location and the offer instance are saved in the user computing device and/or a central management system user account. In an example embodiment, the user selects the offer, and the offer is saved in the user's digital wallet application executing on the user computing device or another computing device. The offer may then be uploaded to the central management system. In an alternative example embodiment, the selected offer is saved on the user computing device, and the offer may then be uploaded to the central management system at any time. In another example embodiment, the user's offers are saved in a data storage unit of the offer system. In an example embodiment, the offer instance and user location are replicated on the user's multiple computing devices. In an example embodiment, the offer instance and user location are saved in the central management system user account, transmitted to one or more user computing devices, and saved. For example, the central management system may maintain a “cloud” account for the user. The information saved in the user's cloud account may be replicated and saved on any computing device the user has associated with the account. The user may access the cloud-based user account through a web browser or user device application. In an alternative example embodiment, the offer system maintains the user's account. In another alternative example embodiment, the offer system is a component of the central management system, or vice versa.

The user accesses saved offer instances using an application resident on the user computing device. If the user computing device cannot identify the user's current location or the application is not integrated with the device's location system, the user's last known location is retrieved. In an example embodiment, the user's last known location is the location saved with the offer instance. In an alternative example embodiment, the user's last known location is a location last identified by the location system or a map application. For example, if the location system last identified the user's location at a particular address, the user device will retrieve this address as the saved location. In another alternative example embodiment, the application determines the most recent and/or most relevant last known location by accessing one or more saved offer instances. For example, if multiple offer instances are saved to the user device with one or more different saved locations, the device may identify the most common or relevant saved location. The user's last known location is retrieved and the nearest redemption locations for one or more saved offers are displayed with the offer(s).

The inventive functionality of the example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

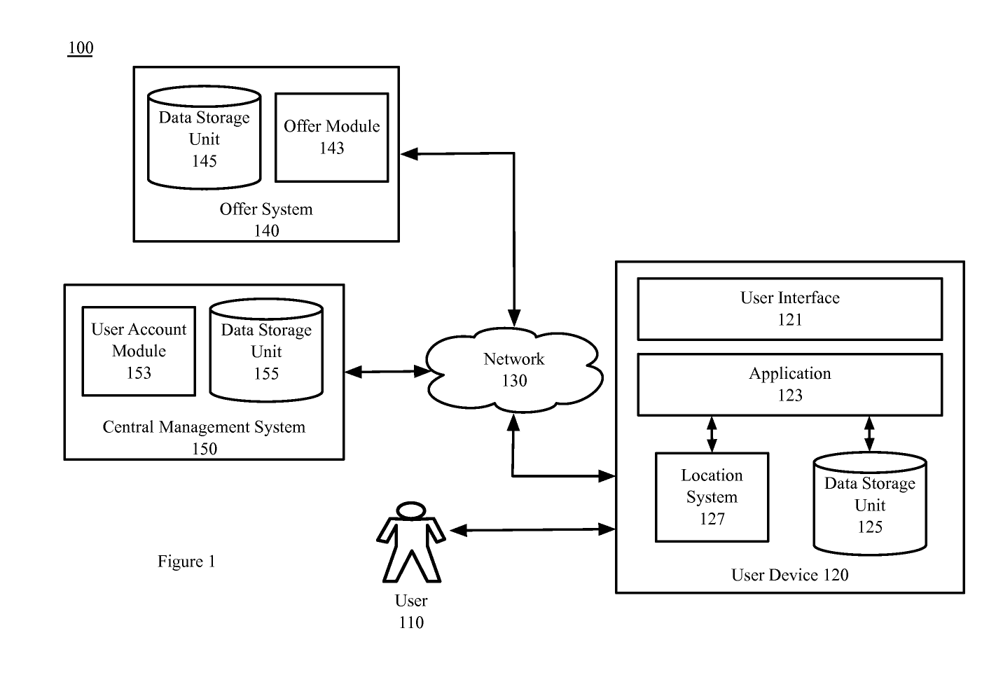

FIG. 1 is a block diagram depicting an example operating environment 100 for an offer presentation system, in accordance with certain example embodiments. As depicted in FIG. 1, the example operating environment 100 includes a user device 120, an offer system 140, and a central management system 150 that are configured to communicate with one another via one or more networks 130.

Each network 130 includes a wired or wireless telecommunication means by which network devices (including devices 120, 140, and 150) can communicate and exchange data. For example, each network 130 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, near field communication network (NFC), or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example embodiment, each network device (including devices 120, 140, and 150) includes a device having a communication module capable of transmitting and receiving data over the network 130. For example, each network system (including devices 120, 140, and 150) may comprise a server, personal computer, mobile device (for example, notebook computer, tablet computer, netbook computer, personal digital assistant (PDA), video game device, GPS locator device, cellular telephone, smartphone, or other mobile device), a television with one or more processors embedded therein and/or coupled thereto, or other appropriate technology that includes or is coupled to a web browser or other application for communicating via the network 130. In the example embodiment depicted in FIG. 1, the network devices (including devices 120, 140, and 150) are operated by end-users 110 or consumers, an online offer provider system, and an online central management system operator, respectively.

In an example embodiment, the user device 120 comprises a user interface 121, an application module 123, a location system module 127, and a data storage unit 125. The application module 123 is a program, function, routine, applet, or similar entity that exists on and performs its operations on the user device 120. For example, the application module 123 may be one or more of an offline or online payment application, a digital wallet application corresponding to a central management system 150 digital wallet application, a coupon application, a loyalty card application, another value-added application, a user interface application, a merchant application corresponding to a merchant application module, or other suitable application operating on the user device 120. In an example embodiment, the application module 123 may be a browser application suitable for interacting with offers maintained by the offer system 140, central management system 150, and/or other network devices.

Web page files can include text, graphics, images, sounds, video, and other multimedia or data files that can be transmitted via the network 130. For example, the web page files can include one or more files in Hypertext Markup Language (HTML). The application module 123 can receive web page files from the offer system 140 and/or central management system 150 and can display the web page files to end users 110 operating the user device 120. The application module 123 also may comprise a mobile application that resides on a mobile device, such as the user device 120, of the user 110. In an example embodiment, the user 110 may access the application module 123 to create, modify, access, or view an account with the offer system 140 and/or central management system 150 (for example, a digital wallet account, personal account, financial account, offer account, or other type of user account) and to access, view, perform a purchase, save, or otherwise interact with an offer presented by the offer system 140.

In an example embodiment, the data storage unit 125 can include any local data storage structure on the user device 120 suitable for storing information. In an example embodiment, the data storage unit 125 stores encrypted information, such as HTML5 local storage.

In an example embodiment, the location system module 127 can include any system or application executing on the user device 120 suitable for tracking or navigating the location of the user device 120. In an example embodiment, the location system module 127 can include a global positioning system (GPS) or other form of navigational facility based on the reception of signals from satellites. In an alternative example embodiment, the location system module 127 can include a web-based mapping service application or other software application capable of creating maps and/or directions including the location of the user device 120.

The offer system 140 comprises an offer module 143 and a data storage unit 145. In an example embodiment, the user 110 creates an account with the offer system 140. The offer module 143 manages the registration of the user 110. Regarding user account registration, the offer module 143 may generate web-based user interfaces providing forms for the user 110 to register for an offer system 140 account. For example, the offer module 143 can collect basic user identifying information, registration information on one or more user devices 120, and payment information. In an example embodiment, the user 110 registers one or more financial card accounts, including bank account debit cards, credit cards, gift cards, or other type of financial account that can be used to make a purchase, with the offer system 140 using the offer module 143. In an example embodiment, the registered financial payment information may be used to complete a purchase by the user 110 with the offer system 140. In an example embodiment, the user account information is stored in a user account or is otherwise associated with the user 110 in the data storage unit 145.

An example offer module 143 receives offers from merchants, manufacturers, and/or other offer creators and distributes the offers to users 110 for review and selection. The offers may be prepaid offers, wherein the user 110 pays a specified amount for the offer prior to redeeming the offer with a merchant. In an alternative example, the user 110 presents the offer to the merchant for redemption without prepaying for the offer.

In an example embodiment, the data storage unit 145 can include any local data storage structure on the offer system 140 suitable for storing information. In an example embodiment, the data storage unit 145 stores encrypted information, such as HTML5 local storage.

The central management system 150 comprises a user account module 153 and a data storage unit 155. In an example embodiment, the user 110 creates an account with the central management system 150. The user account module 153 manages the registration of the user 110. Regarding user account registration, the user account module 153 may generate web-based user interfaces providing forms for the user 110 to register for a central management system 150 account. For example, the user account module 153 can collect basic user identifying information and registration information on one or more user devices 120.

In FIG. 1, the offer system 140 and the central management system 150 are depicted as systems maintained separately. In an alternative example, these systems (140 and 150) may be maintained as part of a single system. In an example embodiment, the user's offer system 140 account and central management system 150 account are the same account. In this example, the user's registration with one system may automatically register the user 110 with the other system.

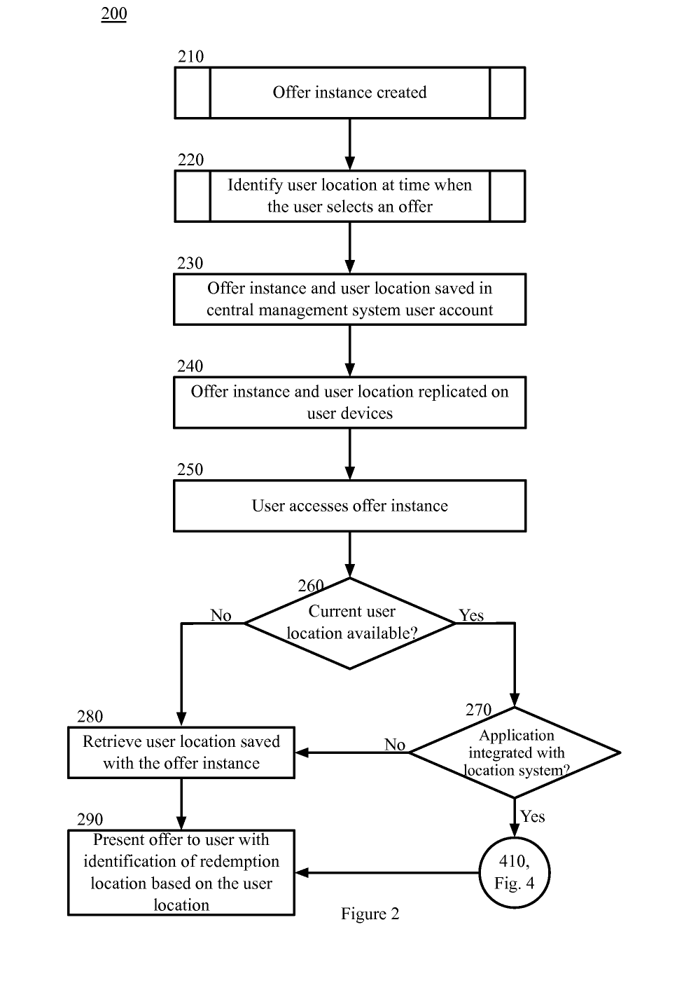

The components of the example operating environment 100 are described further hereinafter with reference to the example methods and systems illustrated in FIGS. 2-5.

### Example Processes

FIG. 2 is a block flow diagram depicting a method 200 for presenting a saved offer with the closest redemption location, in accordance with certain example embodiments. The method 200 is described with reference to the components illustrated in FIG. 1.

In block 210, an offer instance is created. In an example embodiment, an offer is created by a merchant, manufacturer, and/or alternative offer provider and distributed to potential users. An offer provides an incentive for a user 110 to purchase a product. Throughout this specification, the term “product” refers to tangible and intangible products, including services.

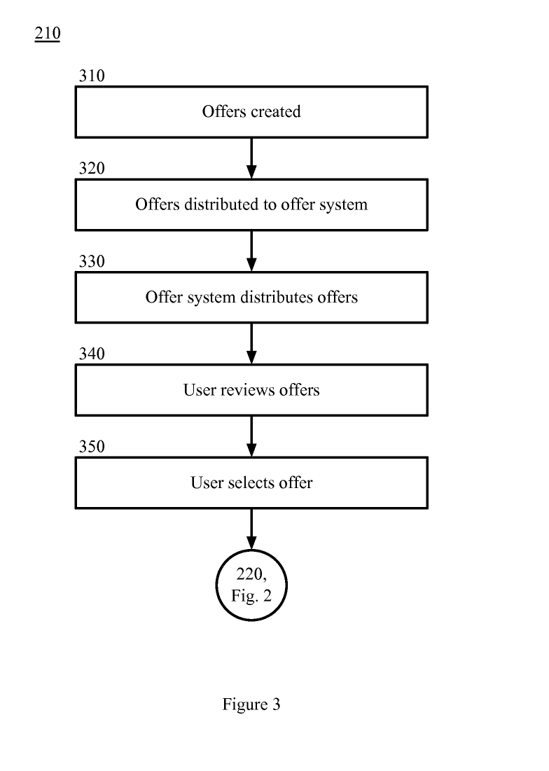

In an example embodiment, the offer is a non-prepaid offer (for example, a loyalty reward, a coupon, discounts, or other offer redeemable with a merchant, manufacturer, service provider, and/or provider of goods). In an alternative example embodiment, the offer is a prepaid offer and the user 110 pays a predetermined price for the goods and/or services. When the user 110 selects and saves a non-prepaid offer and/or selects and purchases a pre-paid offer, an electronic offer instance is created. The method for creating an offer instance is described in more detail hereinafter with reference to the methods described in FIG. 3.

FIG. 3 is a block flow diagram depicting a method 210 for creating an offer instance in accordance with certain example embodiments, as referenced in block 210 of FIG. 2. The method 210 is described with reference to the components illustrated in FIG. 1.

In block 310, an offer is created. In an example embodiment, a merchant, manufacturer, and/or alternative offer provider creates the offer (for example, such offers can include coupons, prepaid offers, loyalty rewards, gift cards, or other suitable offers).

The provider of the offer specifies the offer details, by specifying the type of offer, the duration, the amount of the redemption, and additional pertinent redemption details when creating the offer. In an example embodiment, each offer will have one or more rules or conditions associated therewith, and a transaction must meet the specified rules for redemption of the offer to apply. These rules can include, but are not limited to, a purchase threshold (for example, receive $10 off a single purchase of more than $50 from the merchant), an aggregate purchase threshold (for example, receive $10 off next purchase from the merchant after the accumulated purchase at the merchant has reached $1000), a minimum number of purchases from the merchant (for example, receive $10 off the user's tenth purchase from the merchant), a time restriction (for example, receive $10 off a lunch-time purchase), an expiration date, a specified number of uses of the offer, and/or a location restriction (for example, receive $10 off a purchase at a specified merchant location). In an example embodiment, these rules are set by the creator of the offer.

In an example embodiment, the provider creates an offer by entering the offer details and redemption rules into a computing device to create an electronic record for the offer. In certain example embodiments, the provider may input the offer details and redemption rules directly into the offer system 140 to create an electronic record for the offer in the offer system 140.

In block 320, the offer is distributed to the offer system 140. In an example embodiment, the offer system 140 receives the offer from the merchant, manufacturer, and/or alternative offer provider that created the offer. For example, the provider may communicate the electronic offer record to the offer system 140 via the network 130. As discussed previously, in an alternative embodiment, the provider may create the electronic record for the offer in the offer system 140. The offer module 143 receives the offer record and stores the offer record in the data storage unit 145.

In block 330, the offer system 140 distributes the offer. For example, the offer system 140 distributes the offer via the network 130 to multiple user devices 120 for presentation to the users 110 via the user devices 120.

In an example embodiment, the offer system 140 distributes the offer through network channels selected by the creator of the offer, including display on cost per mille impression (“CPM”), pay per click (“PPC”), electronic correspondence, offers near me, and other advertising methods. In an example embodiment, the offers are cost per acquisition/action (“CPA”) offers, wherein the creator of the offer pays a service fee to the offer system 140 for a specific desired action taken by the user 110 (for example, making a purchase, a subscription, or acceptance of a trial service period). In an alternative example embodiment, the offer is a pay per click (“PPC”) offer, wherein the creator of the offer pays a service fee to the offer system 140 for each time the offer is clicked by a user 110. In another alternative example embodiment, the offer is a cost per mille (“CPM”) or cost per thousand (“CPT”) offers, wherein the creator of the offer pays a service fee to the offer system 140 for every 1000 page views. In yet another alternative example embodiment, the offer is distributed through an “offers near me” model, wherein the offer is displayed in a selected search query that provides results that are physically within a set distance from the user's 110 location. The creator of the offer may select multiple methods of distribution for the same offer. The creator of the offer may also create multiple offers to be distributed through the same or different network channels.

In block 340, a user 110 reviews one or more of the distributed offers that are presented on the user device 120.

In block 350, the user 110 selects one or more offers distributed by the offer system 140 or by others through the various distribution channels. In an example embodiment, the user 110 selects an offer by operating the user device 120 to click on the offer, to press a button to “save” the offer, or by other suitable input to indicate a desire to select and/or save the offer. In an alternative example embodiment, the offer is a prepaid offer, and the user 110 selects the offer by purchasing the offer.

The user 110 can operate the user device 120 to download, select, scan, or otherwise capture the offer and import the offer specifics (such as merchant, product, value, redemption rules, and other specifics) to the user device 120. When the user 110 selects a particular offer, an electronic offer instance is created and stored in the data storage unit 125 of the user device 120.

In an example embodiment, the user 110 may register with a merchant's loyalty rewards program, and offers generated from the loyalty rewards program can be associated with the user device 120. Additionally, the merchant may implement its loyalty rewards program via the offer system 140 such that each purchase by the user 110 from the merchant will increment the loyalty rewards associated with the user's purchase from the merchant. When the user 110 has accumulated sufficient loyalty rewards to qualify for a loyalty rewards offer, the loyalty rewards offer is saved on the user device 120 and then applied when a purchase of the user 110 from the merchant meets the redemption rules for the loyalty rewards offer.

After block 350, the method 210 proceeds to block 220 in FIG. 2.

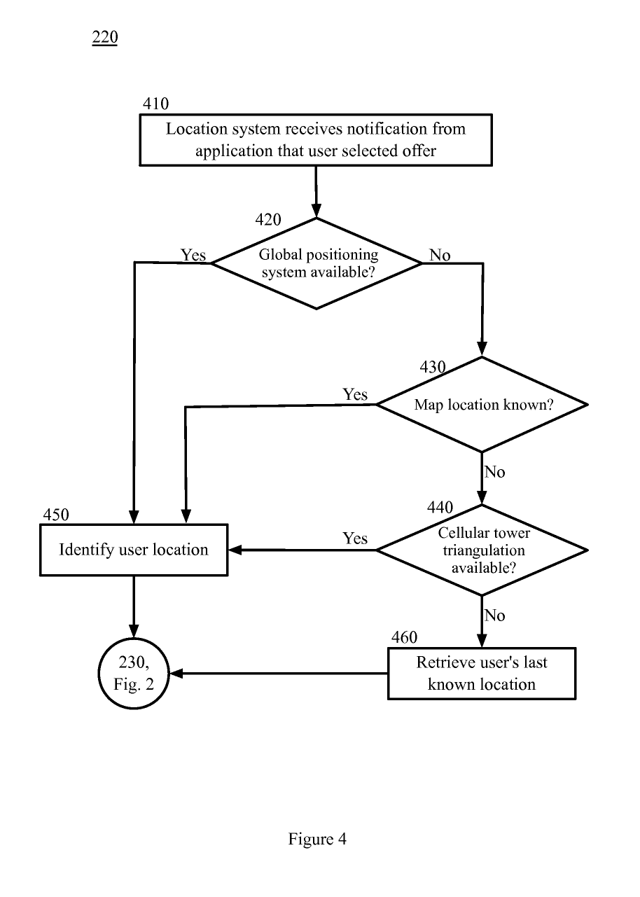

Returning to FIG. 2, in block 220, the user's 110 location at the time of offer selection is identified. The method for identifying a user location is described in more detail hereinafter with reference to the methods described in FIG. 4.

FIG. 4 is a block flow diagram depicting a method 220 for identifying a user location at the time of offer selection, as referenced in block 220 of FIG. 2. The method 220 is described with reference to the components illustrated in FIG. 1.

In block 410, the location system 127 of the receives notification from the application 127 resident on the user device 120 that the user 110 selected the offer. In an example embodiment, the location system 127 attempts to identify the user's 110 location at the time the offer was selected. In an alternative example embodiment, the application 127 monitors inputs of the user 110 into the user device 120 and determines that the user selected an offer to create an offer instance. In response, the application 127 queries the location system 127 for a current location of the user device 120.

In block 420, the location system 127 determines whether a global positioning system (“GPS”) is available on the user device 120. In an example embodiment, GPS includes a navigational system involving satellites and computers that can determine the latitude and longitude of a receiver included in the user device 120 by computing the time difference for signals from different satellites to reach the receiver.

If GPS is available on the user device 120, the method 220 proceeds to block 450. In block 450, the location of the user device is identified based on location information available from the GPS. For example, the GPS may communicate the current location information to the location system 127. Alternatively, the location system 127 may read the current location information from the GPS or data associated with the GPS. The location system 127 then communicates the current location information to the offer application 123 for use in connection with the offer instance.

Returning to block 420, if GPS is not available on the user device 120, the method 220 proceeds to block 430. In block 430, the location system 127 determines whether a map location is known for the user device 120. In an example embodiment, the user 110 may browse offers available near the location of the user. In this embodiment, the offers may be presented using a map application 123 on the user device 120. In an alternative example embodiment, a map application 123 may be accessed to determine the user's 110 location or last known location. In an alternative example embodiment, the offer system 140 or central management system 150 determines whether a current map location is known.

If a map location is available from a map application 123 monitoring the location of the user device 120, the method 220 proceeds to block 450. In block 450, the location of the user device is identified based on location information available from the map application 123. For example, the map application 123 may communicate the current location information to the location system 127. Alternatively, the location system 127 may read the current location information from the map application 123 or data associated with the map application 123. The location system 127 then communicates the current location information to the offer application 123 for use in connection with the offer instance.

Returning to block 430, if a map location is not known, the method 220 proceeds to block 440.

In block 440, the location system 127 determines whether a location based on a cellular tower triangulation is available for the user device 120. In an example embodiment, the user device 120 is a cellular device, and the user's 110 location can be determined by multilateration of radio signals between radio towers of the cellular network and the user device 120. In an alternative example embodiment, the offer system 140 or central management system 150 determine the location of the user device 120 using cellular tower triangulation. Alternatively, the cellular network or network provider may determine the location of the user device 120 and communicate that location to the location system 127 of the user device 120.

If a cellular tower triangulation location is available, the method 220 proceeds to block 450. In block 450, the location of the user device is identified based on location information available from an application 123 associated with the triangulation information. For example, the application 123 may communicate the current location information to the location system 127. Alternatively, the location system 127 may read the current location information from the application 123 or data associated with the application 123. The location system 127 then communicates the current location information to the offer application 123 for use in connection with the offer instance.

Returning to block 440, if a triangulation location is not available for the user device 120, the method 220 proceeds to block 460.

Blocks 420-450 describe example methods for determining a current location of the user device 120. However, other methods for determining a location of the user device 120 are suitable. For example, in alternative example embodiments, the user's location may be determined by mapping based on the user's 110 IP address. In an alternative example embodiment, the user 110 may be prompted to enter into the user device 120 a current location when the offer is selected. Additionally, the user 110, the user device 120, and/or the application 123 may set a default location to be saved with selected offers.

If current location information is not available via blocks 420-440, in block 460, the location system 127 retrieves a last known location of the user device 120. In an example embodiment, the location system 127, offer system 140, and/or central management system 150 are unable to determine the user's 110 current location. In this embodiment, the location system 127 retrieves the last saved or identified location of the user 110 from the data storage unit 125. For example, and previously saved location data obtained via methods described previously with reference to blocks 420-450 may serve as the last known location of the user device 120. In an example embodiment, the user 110 has previously selected an offer, and the location system 127 was successfully able to identify the location of the user device 120 at the time the user 110 selected that offer. In an alternative example embodiment, the location system 127 retrieves the last known location of the user device 120 from an application 123 resident on the user device 120 and having previously saved that information.

From either block 450 or 460, the method 220 proceeds to block 230 in FIG. 2.

Returning to FIG. 2, in block 230, the offer instance and the user location are saved in a user account of the central management system 150. In an example embodiment, the user 110 selects the offer and it is saved in the user's 110 digital wallet application 123 and/or data storage unit 125, which may then be uploaded to the central management system 150. In an alternative example embodiment, the selected offer is saved on the user device 120, which may then be uploaded to the central management system 150 at any time. In another example embodiment, the user's 110 offers are communicated to and saved in the data storage unit 145 of the offer system 140.

In an alternative example embodiment, an offer may be displayed in the form of a coupon in response to the user's 110 Internet search. The user 110 can download the offer to the user device 120 and store the offer in the data storage unit 125, which may then be uploaded to the central management system 150 and/or offer system 140.

In block 240, the offer instance and user location combination is replicated on user devices 120, the offer system 140, and/or the central management system 150. In an example embodiment, the offer instance and user location combination was saved in the central management system 150 user account in block 230. In this embodiment, the saved offer instance and user location can be transmitted to one or more user devices 120 and/or the offer system 140 and saved locally in those components. For example, the central management system 150 may maintain a cloud account for the user 110. The information saved in the user's cloud account may be replicated and saved on any device the user has associated with the account. The user 110 may access the cloud-based user account through a web browser or user device application 123 executing on the user device 120.

In an alternative example embodiment, the offer system 140 maintains the user's account. In another alternative example embodiment, the offer system 140 is a component of the central management system 150, or vice versa.

In an example embodiment, the user 110 submits registration information to the central management system 150, which can include, but is not limited to, name, address, phone number, e-mail address, and information for one or more registered financial card accounts (including bank account debit cards, credit cards, loyalty rewards account cards, or gift cards, or other type of account that can be used to make a purchase).

In an alternative example embodiment, the user 110 may be prompted to register with the central management system 150 and/or offer system 140 when the user 110 clicks on or selects an offer. In an alternative example embodiment, the user 110 may use an application 123 to register with the central management system 150 and/or offer system 140.

In response to registration by the user 110, the central management system 150 and/or offer system 140 creates a user account for the user 110, including the registration information provided by the user. The central management system 150 and/or offer system 140 also may generate a user account identifier for the user's account.

In an example embodiment, the user's account with the central management system 150 and/or offer system 140 is a generic account. For example, the user's account is not limited to a particular merchant or to offers with a particular merchant. The user's account can be mapped to multiple merchants. Then, when the user shops at a particular merchant, all offers for the particular merchant or for products sold by the particular merchant that are saved in the user's account with the central management system 150 and/or offer system 140 can be presented and/or redeemed for the purchase with the particular merchant. In this case, the user 110 does not have to keep track of separate accounts for each merchant or load product coupons or other offers into the separate accounts for each merchant.

In block 250, the user 110 accesses the offer instance. In an example embodiment, the user 110 accesses the offer instance using an offer application 123 executing on the user device 120. The offer application 123 may display one or more of the user's saved offer instances when the offer application 123 is accessed. For example, the user 110 may instantiate the offer application 123. Upon startup, the offer application 123 can access the user's stored offer instances. Alternatively, the user 110 may select a particular stored offer instance via the offer application 123.

In block 260, the offer system 123 determines whether the current location of the user device 120 is discoverable. In an example embodiment, the offer system 123 queries the location system 127 executing on the user device 120 to obtain the current location of the user device 120.

In an example embodiment, the location system 127 may use one or more of the methods described in FIG. 4 to determine if the current location of the user device 120 is or is not discoverable, including, but not limited to GPS, map applications, and cellular tower triangulation.

If the current location of the user device 120 is discoverable, the method 200 proceeds to block 270.

In block 270, the user device 120 determines whether the offer application 123 is integrated with the location system 127. In an example embodiment, the offer application 123 has not been enabled to receive, access, or otherwise communicate data with the location system 127. In this example embodiment, the offer application 123 may not be integrated with the location system 127. For example, the user 110 may have disabled the location system 127 and/or offer application 123 or refused to allow the offer application 123 to receive location data when given that option during installation or configuration of the offer application 123 or location system 127.

If the application 123 is integrated with the location system 127, the method 200 proceeds to block 410 in FIG. 4 and the current location of the user device 120 is identified based on the methods described previously with reference to FIG. 4.

Returning to block 260, if the current location of the user device 120 is not discoverable, the method 200 proceeds to block 280. Additionally, returning to block 270, if the offer application 123 is not integrated with the location system 127, the method 200 proceeds to block 280.

In block 280, the user device 120 retrieves the user's location saved with the offer instance in blocks 230-240. In an example embodiment, the offer instance and user location were replicated to the user device 120 in block 240. In this embodiment, the user device 120 retrieves the saved user location and offer instance from the application 123 and/or data storage unit 125. In an alternative example embodiment, the user device 120 retrieves the saved user location and offer instance from the central management system 150 user account and/or the offer system 140 user account. In any case, the offer application 123 executing on user device may query the appropriate component, system, or application to obtain the saved information.

In an example embodiment, the user device 120 identifies the last known location of the device 120. For example, if the location system 127 last identified the user's location at a particular address, the user device 120 will retrieve this address as the saved location. In an alternative example embodiment, the user device 120 will identify the last (in other words, most recent) location saved with any offer instance. In another alternative example embodiment, the last known location was saved by an application to a central store and retrieved by the location system 127 and/or application 123, for example, the user 110 has “checked in” to a location. In an alternative example embodiment, information in a near field communication (“NFC”) terminal can provide location data to the user device 120.

In an alternative example embodiment, multiple offer instances are saved to the user device 120 with one or more different saved locations. The user device 120 will identify the most common or relevant saved location. For example, the user device 120 contains nine offer instances saved in New York City and two offer instances saved in San Francisco. The user device 120 will identify New York City as the saved location based on a higher probability of the user device being located in New York City.

In block 290, the accessed offer is presented to the user 110 with an identification of one or more redemption locations based on the user location. In an example embodiment, the user location is the current location of the user device 120 identified in FIG. 4, after block 270. In an alternative example embodiment, the user's location is the location of the user device 120 saved with the offer instance. In an alternative example embodiment, the user's location is the location of the user device 120 determined in block 280 described previously.

In an example embodiment, the user is presented with the selected offer on a map identifying the redemption location(s). In an alternative example embodiment, the application 123 lists or otherwise displays the offer and the redemption location.

In another example embodiment, the offer application 123 may present on the user device 120 one or more saved offers and their corresponding relative location with regard to the current or last known location of the user device 120. In this case, the user 110 may not access a specific offer to obtain the offer information. Instead, the user 110 requests information for nearby offers.

### Other Example Embodiments

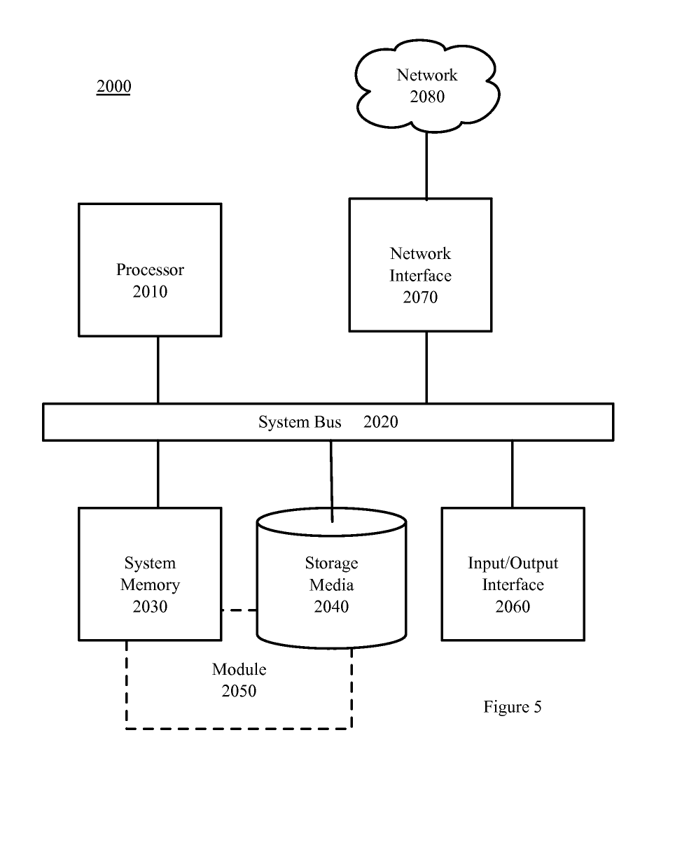

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a Smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for presenting saved offers, comprising:
receiving, by a user computing device, a selection of an offer, wherein the selection of the offer is related to a display of the offer on the user computing device;
determining, by the user computing device, a first location of the user computing device;
associating, by the user computing device, the selected offer with the first location of the user computing device;
receiving, by the user computing device, a request to access the selected offer;
determining, by the user computing device, whether a second location of the user computing device is available, the second location of the user computing device being a location of the user computing device at a time associated with receiving the request to access the selected offer;
in response to determining that the second location of the user computing device is unavailable at the time of receiving the request to access the selected offer, reading, by the user computing device, the first location of the user computing device;
determining, by the user computing device, one or more merchants in proximity to the read first location of the user computing device; and
presenting, by the user computing device, the selected offer and the one or more merchants in proximity to the read first location of the user computing device.

2. The computer-implemented method of claim 1, further comprising determining, by the user computing device, whether an offer application executing on the user computing device is integrated with a location system application executing on the user computing device, wherein the location system determines whether the second location of the user computing device is available if the offer application executing on the user computing device is integrated with the location system application executing on the user computing device.

3. The computer-implemented method of claim 1, wherein the offer is a prepaid offer, a coupon, or a loyalty reward.

4. The computer-implemented method of claim 1, wherein the user computing device is a mobile phone.

5. The computer-implemented method of claim 1, wherein the user computing device is a personal computer, mobile device, or a television.

6. The computer-implemented method of claim 1, wherein associating the selected offer and the first location of the user computing device comprises:
saving, by a central management system, the selected offer and the first location of the user computing device; and
replicating, by the central management system, the selected offer and the first location of the user computing device to the user computing device.

7. The computer-implemented method of claim 1, wherein the first location of the user computing device is a location of the user computing device at the time associated with receiving the selection of the offer.

8. The computer-implemented method of claim 1, wherein the first location of the user computing device comprises a last known location of the user computing device.

9. The computer-implemented method of claim 1, wherein the first location of the user computing device comprises a most relevant, last known location of the user computing device.

10. A computer program product, comprising:
a non-transitory computer-readable medium having computer-readable program instructions embodied therein that when executed by a computer perform a method for presenting saved offers, the computer-readable program instructions comprising:
computer-readable program instructions for receiving, by a user computing device, a selection of an offer, wherein the selection of the offer is related to a display of the offer on the user computing device;
computer-readable program instructions for receiving, by the user computing device, a request to access the selected offer;
computer-readable program instructions for determining, by the user computing device, that a second location of the user computing device is unavailable, the second location of the user computing device being a location of the user computing device at a time associated with receiving the request to access the selected offer;
computer-readable program instructions for reading, by the user computing device, a first location of the user computing device, the first location of the user computing device associated with the selected offer;
computer-readable program instructions for determining, by the user computing device, one or more merchants in proximity to the read first location of the user computing device; and
computer-readable program instructions for presenting, by the user computing device, the selected offer and the one or more merchants in proximity to the read first location of the user computing device.

11. The computer program product of claim 10, further comprising computer-readable program instructions for determining, by the user computing device, whether an offer application executing on the user computing device is integrated with a location system application executing on the user computing device, wherein the location system determines whether the second location of the user computing device is available if the offer application executing on the user computing device is integrated with the location system application executing on the user computing device.

12. The computer program product of claim 10, wherein the offer is a prepaid offer, a coupon, or a loyalty reward.

13. The computer program product of claim 10, wherein the user computing device is a mobile phone.

14. The computer program product of claim 10, wherein the user computing device is a personal computer, mobile device, or a television.

15. The computer program product of claim 10, wherein associating the selected offer and the first location of the user computing device comprises:
computer-readable program instructions for saving, by a central management system, the selected offer and the first location of the user computing device; and
computer-readable program instructions for replicating, by the central management system, the selected offer and the first location of the user computing device to the user computing device.

16. The computer program product of claim 10, wherein the first location of the user computing device is a location of the user computing device at the time associated with receiving the selection of the offer.

17. The computer program product of claim 10, wherein the first location of the user computing device comprises a last known location of the user computing device.

18. The computer program product of claim 10, wherein the first location of the user computing device comprises a most relevant, last known location of the user computing device.

19. A system for presenting saved offers, the system comprising:
a storage medium; and
a processor configured to execute computer-executable instructions stored in the storage medium, the computer-executable instructions comprising:
instructions for receiving a selection of an offer presented, wherein the selection of the offer is related to a display of the offer on a user computing device;
instructions for determining a first location of the user computing device obtained at a time associated with receiving the selection of the offer;
instructions for associating the selected offer with the first location of the user computing device;
instructions for receiving a request to access the selected offer;
instructions for reading the first location of the user computing device associated with the selected offer;
instructions for presenting the selected offer and one or more merchants in proximity to the read first location of the user computing device.

20. The system of claim 19, wherein the offer is a prepaid offer, a coupon, or a loyalty reward.

21. The system of claim 19, further comprising instructions for determining that a second location of the user computing device is unavailable, the second location of the user computing device being a location of the user computing device at a time of receiving the request to access the selected offer.

22. The system of claim 19, wherein associating the selected offer and the first location of the user computing device comprises:
instructions for saving the selected offer selected and the first location of the user computing device; and
instructions for replicating the selected offer selected and the first location of the user computing device to the user computing device.

23. The system of claim 19, further comprising instructions for determining whether an offer application executing on the user computing device is integrated with a location system application executing on the user computing device, wherein the location system determines whether the second location of the user computing device is available if the offer application executing on the user computing device is integrated with the location system application executing on the user computing device.

24. The system of claim 19, wherein the first location of the user computing device is a location of the user computing device at the time associated with receiving the selection of the offer.

25. The system of claim 19, wherein the first location of the user computing device comprises a last known location of the user computing device.

26. The system of claim 19, wherein the first location of the user computing device comprises a most relevant, last known location of the user computing device.
